(19) United States
(12) Patent Application Publication
(10) Pub. No.: US 2018/0063438 A1
(43) Pub. Date: Mar. 1, 2018

(54) Dual Camera Assemblies With Optical Image Stabilization

(71) Applicant: Hutchinson Technology Incorporated, Hutchinson, MN (US)

(72) Inventors: Mark A. Miller, Hutchinson, MN (US); Chee K. Lai, DongGuan City (CN)

(21) Appl. No.: 15/685,513

(22) Filed: Aug. 24, 2017

Related U.S. Application Data
(60) Provisional application No. 62/378,738, filed on Aug. 24, 2016.

(51) Int. Cl. H04N 5/232; G02B 13/00; G02B 7/02; G02B 27/64

(52) U.S. Cl. CPC H04N 5/23258; G02B 13/001; G02B 27/646; G02B 7/023; H04N 5/23287

(57) ABSTRACT

A camera lens assembly is described. The camera lens assembly includes a plurality of optical image stabilization assemblies. Each of the plurality of optical image stabilization assemblies includes a plurality of shape memory alloy wires and is configured to receive an autofocus assembly. And, the camera lens assembly includes a base configured to support the plurality of optical image stabilization assemblies.

### CROSS-REFERENCE TO RELATED APPLICATIONS

This application claims priority from U.S. Provisional Patent Application No. 62/378,738, filed on Aug. 24, 2016, which is hereby incorporated by reference in its entirety.

### FIELD

The invention relates generally to cameras having multiple lenses, including those incorporated into mobile devices such as phones and tablets. In particular, the invention relates to such cameras having optical image stabilization systems and an auto focus system.

### BACKGROUND

Shape memory alloy (SMA) camera lens optical image stabilization (OIS) assemblies are generally known and disclosed, for example, in the Miller U.S. Pat. No. 9,366,879, the Ladwig U.S. Patent Application Publication 2016/0154251, and PCT International Application Publication Nos. WO 2014/083318 and WO 2013/175197, all of which are incorporated herein by reference in their entireties and for all purposes. Such assemblies may include a moving member mounted to a support member. A base can be mounted to the side of the support member opposite the moving member. OIS assemblies of these types can have a lens holder with an auto focus (AF) assembly or system mounted thereto (e.g., to the moving member). A screening can may be mounted to the base to enclose the OIS assembly and AF assembly.

### SUMMARY

A camera lens assembly is described. The camera lens assembly includes a plurality of optical image stabilization assemblies. Each of the plurality of optical image stabilization assemblies includes a plurality of shape memory alloy wires and is configured to receive an autofocus assembly. And, the camera lens assembly includes a base configured to support the plurality of optical image stabilization assemblies.

Other features and advantages of embodiments of the present invention will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates a dual OIS/AF camera assembly having a single base according to an embodiment;

FIG. 2 illustrate a dual OIS/AF camera assembly having a single base and a single screening can according to an embodiment;

FIG. 3 illustrates a dual OIS/AF camera assembly having a single base that supports multiple OIS assemblies and AF assemblies according to an embodiment;

FIG. 4 illustrates a dual OIS/AF camera assembly having a single base and a single screening can with a wall according to an embodiment; and

FIG. 5 illustrates an integrated OIS assembly having a one-piece support member and a one-piece moving member according to an embodiment.

### DETAILED DESCRIPTION

Embodiments of the invention include dual (i.e., multiple) camera OIS and AF assemblies such as those shown in the Miller patent and Ladwig publication. The use of a single base configured to use multiple OIS assemblies 104 and/or multiple AF assemblies provides the benefit of using current designs for each of the OIS and AF assemblies and the screening cans. Thus, the same tools and techniques for manufacturing a single assembly can be used to manufacture the multiple OIS and/or multiple AF assemblies on the single base. Moreover, the use of a single base provides more uniformity of flatness over designs that use multiple OIS and AF assemblies each having their own, independent base. Further, the use of a single base provides the use of a closed loop AF design.

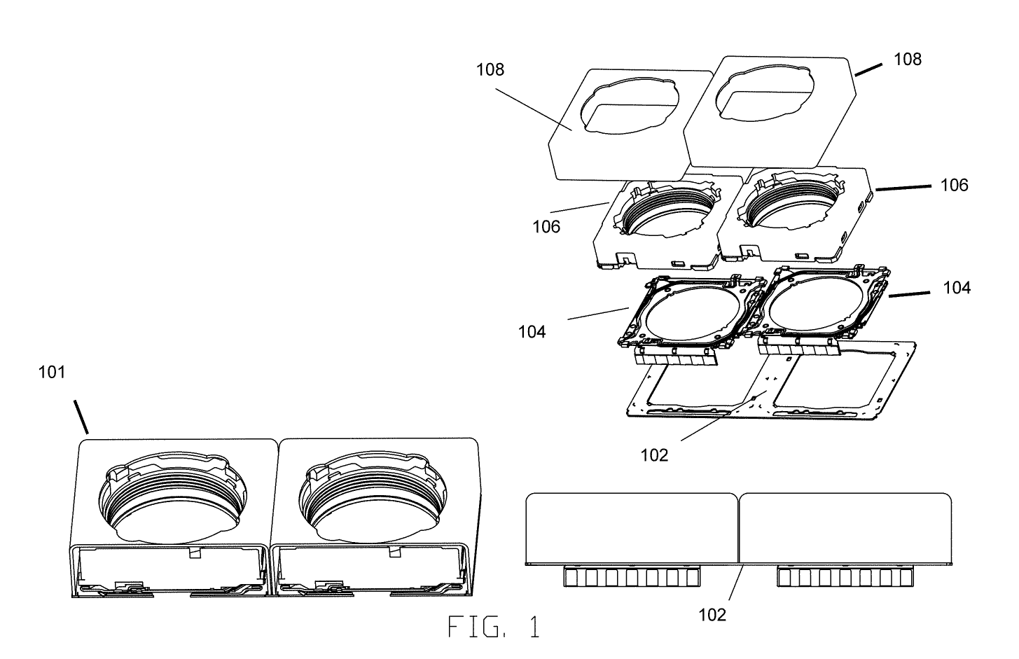

FIG. 1 illustrates an embodiment of a dual OIS/AF camera assembly 101 having a single base 102 that supports multiple OIS assemblies 104, multiple AF assemblies 106 and multiple screening cans (SC) 108. The base 102 can be formed as a unitary and one-piece member (e.g., from the same piece of material). In other embodiments, the single base 102 is formed from two separate elements that are joined together (e.g., by adhesive or welds). According to an embodiment, the OIS assemblies 104 are shape memory alloy (SMA) camera lens optical image stabilization (OIS) assemblies that use SMA wires to generate motion of a moving member of the OIS assembly that is perpendicular to the base 102, for example in a direction of a z-axis, using techniques including those known in the art. An AF assembly 106 included in a dual OIS/AF camera assembly 101 may include a voice coil magnet actuator (VCM) AF assembly or an SMA actuator AF assembly. A VCM AF assembly uses a voice coil magnet actuator to generate a motion in a direction perpendicular to the single base 102, for example in the direction of the z-axis of the dual OIS/AF camera assembly 101, using techniques including those known in the art. An SMA actuator AF assembly uses SMA actuators to generate a motion in a direction perpendicular to the single base 102, for example in the direction of the z-axis of the dual OIS/AF camera assembly 101, using techniques including those known in the art.

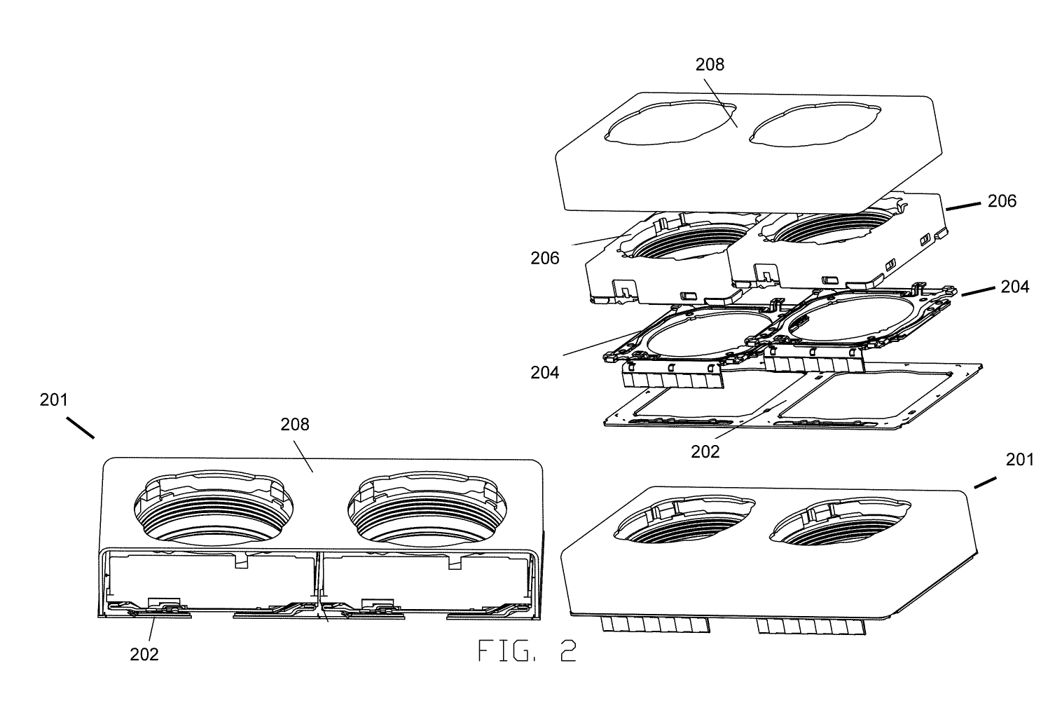

FIG. 2 illustrates an embodiment of a dual OIS/AF camera assembly 201 having a single base 202 that supports multiple OIS assemblies 204, multiple AF assemblies 206, and a single screening can 208. The screening can 208 may be formed as a unitary and one-piece member (e.g., from the same piece of material). In other embodiments, the single screening can 208 is formed from two separate elements that are joined together (e.g., by adhesive or welds).

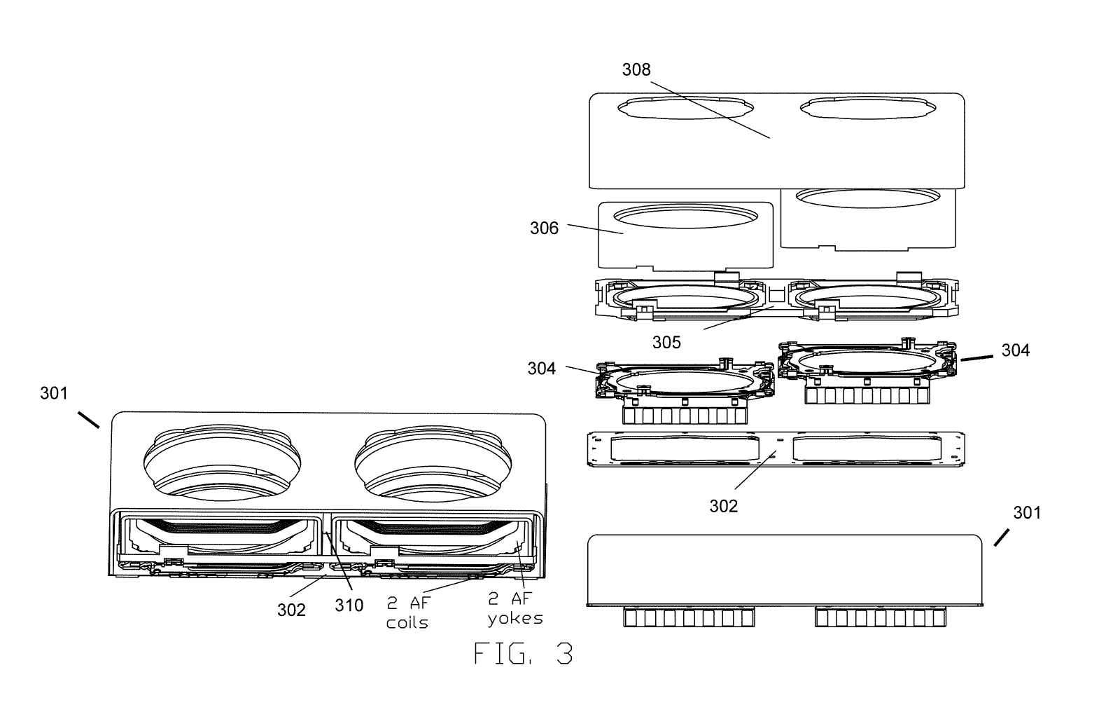

FIG. 3 illustrates an embodiment of a dual OIS/AF camera assembly 301 having a single base 302 that supports multiple OIS assemblies 304, multiple AF assemblies 306, and a single screening can 308. A single AF base 305 is mounted to the moving members of the two OIS assemblies 304. Each of the AF assemblies 306 is mounted to the single AF base 305. The AF base 305 may be formed as a unitary and one-piece member (e.g., from the same piece of material). In other embodiments, the single AF base 305 is formed from two separate elements that are joined together (e.g., by adhesive or welds). According to various embodiments, the screening can 308 includes a wall 310 between the AF assemblies 306. The wall 310 is configured to maintain the position of the AF assemblies 306 and OIS assemblies 304. More particularly, the wall 310 is configured to ensure that during a shock event when both OIS assemblies 304 and an AF assemblies 306 move the same maximum distance in each of the direction of an x axis, for example in the direction of the longitudinal axis of the base 302, and in the direction of a y-axis, for example in the direction of the lateral axis of the base 302. Thus, the wall 310 is configured to act a guide to prevent the OIS assemblies 304 from moving farther in the direction of the x axis verses the direction in the y axis. This could result in damage to the SMA wires of the OIS assemblies 304, for example the SMA wires could be deformed past their recoverable range.

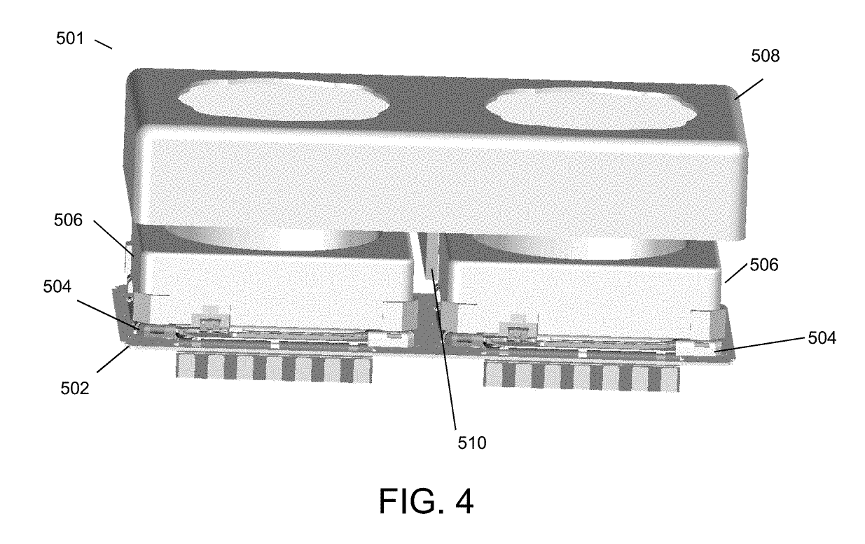

FIG. 4 illustrates an embodiment of a dual OIS/AF camera assembly 501 having a single base 502 that supports multiple OIS assemblies 504, multiple AF assemblies 506, and a single screening can 508. The screening can 508 includes a wall 510 between the AF assemblies 506. The wall 510 is configured to extend down between the OIS assemblies 504 to provide end stop protection for the SMA wires of the OIS assemblies 504 to prevent damage to the SMA wires. The wall 510 is configured to maintain the position of the AF assemblies 506 and OIS assemblies 504. More particularly, the wall 510 is configured to ensure that during a shock event when both OIS assemblies 504 and an AF assemblies 506 move the same maximum distance in each of the direction of an x axis, for example in the direction of the longitudinal axis of the base 502, and in the direction of a y-axis, for example in the direction of the lateral axis of the base 502. Thus, the wall 510 is configured to act a guide to prevent the OIS assemblies 504 from moving farther in the direction of the x axis verses the direction in the y axis. This could result in damage to the SMA wires of the OIS assemblies 504, for example the SMA wires could be deformed past their recoverable range. According to various embodiments, the wall 510 is formed integrally with the screening can 508. For an example, the wall 510 can be molded to include a wall 510. For other embodiments, the wall 510 is a separate piece that is attached to the screening can 508, using techniques known in the art such as welding or adhesive.

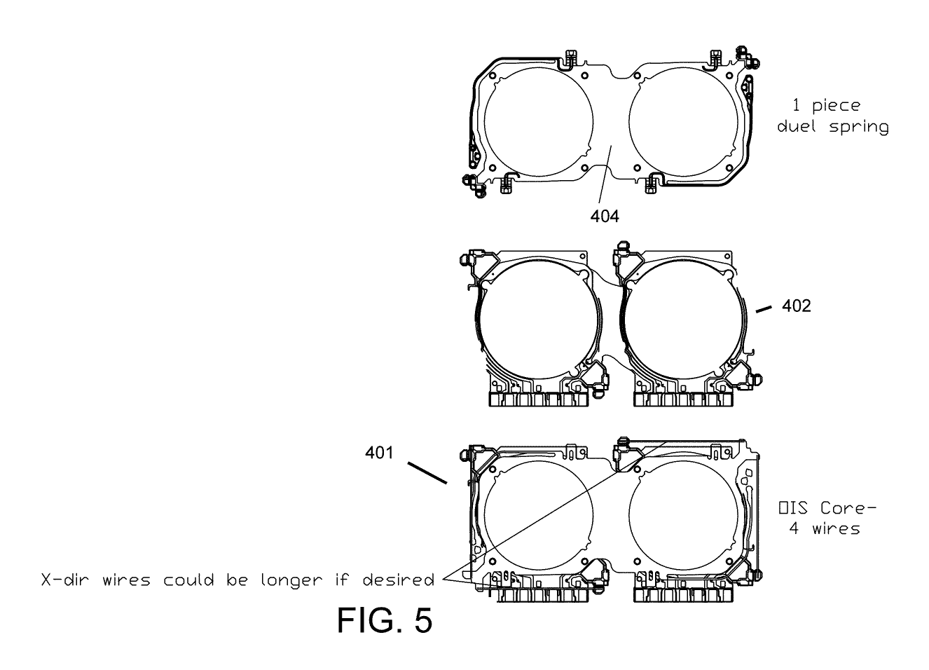

FIG. 5 illustrates an embodiment having an integrated OIS assembly 401 having a one-piece support member and a one-piece moving member. As shown, the base layer or plate portions of the support member 402 and moving member 404 are each formed from a unitary and one-piece member (e.g., from the same piece of material). In other embodiments, each of the one-piece support member 402 and moving member 404 base layers are formed from two separate elements that are joined together (e.g., by welds). In still other embodiments, one of the OIS support member 402 and moving member 404 can have two separate base layer members. According to some embodiments, the integrated OIS assembly 401 uses 4 SMA wires, which are attached to the OIS assembly using 8 attach structures, such as crimps. The SMA wires are used to move the OIS assembly in a direction perpendicular to the OIS assembly, for example the direction is in the z-axis, using SMA techniques including those known in the art. According to some embodiments, the SMA wires in one direction, for example in the x direction, are longer than the SMA wires in the other direction, for example the y direction.

Embodiments of the invention offer important advantages. The multiple lenses of the cameras can be made flat with respect to each other. The assemblies can be relatively low cost, high stroke (with high suppression). They can be used with both open loop and closed loop AF configurations (e.g., 2 traces for open loop AF and 4 traces for closed loop AF). SMA assemblies of these types have no magnetic interference, relatively low footprint and superior flatness, and reduced cost by integrating components. Embodiments as describes herein can be used with voice coil magnet actuator (VCM) AF assemblies as well as SMA actuator AF assemblies. The use of VCM AF assemblies will generate some magnetic interference, in contrast to the use of SMA actuator AF assemblies used with SMA OIS assemblies that will not generate magnetic interference.

Although the invention has been described with reference to different embodiments, those of skill in the art will recognize that changes can be made in form and detail without departing from the spirit and scope of the invention. For example, although described as dual camera assemblies, other embodiments of the invention are configured for three or more cameras. Features of the different illustrated embodiments can be combined with one another in still other embodiments. The specification and drawings are, accordingly, to be regarded in an illustrative rather than a restrictive sense.

What is claimed is:

1. A multiple shape memory alloy optical image stabilization (OIS) camera of the type having a base, OIS assembly, AF assembly and screening can, including one or more of: (1) a single base; (2) a single screening can; (3) a single AF base; and (4) a single OIS assembly.

2. The multiple camera of claim 1 wherein the single OIS assembly includes a support member and a moving member, and wherein one or both of the support member and the moving member have a single base layer.

3. The multiple camera of claim 2 wherein the moving member has two spring arms and four SMA wire attach structures such as crimps.

4. A camera lens assembly comprising:
a plurality of optical image stabilization assemblies, each of the plurality of optical image stabilization assemblies including a plurality of shape memory alloy wires and configured to receive an autofocus assembly; and
a base configured to support the plurality of optical image stabilization assemblies.

5. The camera lens assembly of claim 4, wherein each of the plurality of optical stabilization assemblies includes a moving member and a support member.

6. The camera lens assembly of claim 4, wherein the plurality of optical stabilization assemblies share a one-piece support member.

7. The camera lens assembly of claim 6, wherein the plurality of optical stabilization assemblies share a one-piece moving member.

8. The camera lens assembly of claim 6, wherein the one-piece support member is formed from multiple elements joined together.

9. The camera lens assembly of claim 7, wherein the one-piece moving member is formed from multiple elements joined together.

10. The camera lens assembly of claim 4 further including a plurality of autofocus assemblies.

11. The camera lens assembly of claim 10, wherein the plurality of autofocus assemblies are mounted to the optical image stabilization assemblies using a single autofocus base.

12. The camera lens assembly of claim 10 further comprising a plurality of screening cans.

13. The camera lens assembly of claim 10 further comprising a single screening can configured to cover at least a portion of each of the plurality of optical image stabilization assemblies and each of the plurality of autofocus assemblies.

14. The camera assembly of claim 13, wherein the single screening can is formed from multiple elements joined together.

15. The camera assembly of claim 10, wherein the plurality of autofocus assemblies are configured to generate motion using SMA actuators.

16. The camera assembly of claim 13, wherein the single screening can includes a wall positioned between at least two of the plurality of autofocus assemblies.

17. An assembly comprising:
at least two optical image stabilization assemblies, each of the two optical image stabilization assemblies including a plurality of shape memory alloy wires configured to move a moving member in relation to a support member, each of the two optical image stabilization configured to receive an autofocus assembly; and
a base configured to support the at least two optical image stabilization assemblies.

18. The assembly of claim 17, wherein the support member for each of the two optical stabilization assemblies are joined together to form a one-piece support member.

19. The assembly of claim 18, wherein the moving member for each of the two optical stabilization assemblies are joined together to form a one-piece moving member.

20. The assembly of claim 17 further including at least two autofocus assemblies.

21. The assembly of claim 20, wherein the at least two autofocus assemblies are mounted to the at least two optical image stabilization assemblies using a single autofocus base.

22. The assembly of claim 17 further comprising a plurality of screening cans.

23. The assembly of claim 20 further comprising a single screening can configured to cover at least a portion of each of the two optical image stabilization assemblies and each of the at least two autofocus assemblies.

24. The assembly of claim 20, wherein the at least two autofocus assemblies are configured to generate motion in a direction perpendicular to the base using SMA actuators.

25. The camera assembly of claim 23, wherein the single screening can includes a wall positioned between the two autofocus assemblies and the two optical image stabilization assemblies.
